(19) United States
(12) Patent Application Publication
(10) Pub. No.: US 2015/0092967 A1
(43) Pub. Date: Apr. 2, 2015

(54) SYSTEM AND METHOD FOR SELECTIVE HARMONIC ENHANCEMENT FOR HEARING ASSISTANCE DEVICES

(71) Applicants: Kelly Fitz, Eden Prairie, MN (US); Karrie LaRae Recker, Edina, MN (US); Donald James Reynolds, Pacifica, CA (US); Kamil Wojcicki, Eden Prairie, MN (US)

(72) Inventors: Kelly Fitz, Eden Prairie, MN (US); Karrie LaRae Recker, Edina, MN (US); Donald James Reynolds, Pacifica, CA (US); Kamil Wojcicki, Eden Prairie, MN (US)

(73) Assignee: Starkey Laboratories, Inc., Eden Prairie, MN (US)

(21) Appl. No.: 14/043,320

(22) Filed: Oct. 1, 2013

(51) Int. Cl. H04R 25/00

(52) U.S. Cl. CPC H04R 25/453; H04R 2225/43
USPC 381/317

(57) ABSTRACT

Disclosed herein, among other things, are systems and methods for improved noise reduction for hearing assistance devices. One aspect of the present subject matter includes a method of enhancing speech in an audio signal for a hearing assistance device. An audio signal is received from a hearing assistance device microphone in a user acoustic environment, and speech components are identified and isolated from the audio signal. The speech components are harmonically enhanced in parallel with a primary path of the audio signal, in various embodiments. In various embodiments, the harmonically enhanced speech components are mixed with the audio signal to improve speech intelligibility, clarity or audibility for a user of the hearing assistance device

### CROSS REFERENCE TO RELATED APPLICATIONS

This application is related to co-pending, commonly assigned, U.S. patent application Ser. No. 13/568,618, entitled “COMPRESSION OF SPACED SOURCES FOR HEARING ASSISTANCE DEVICES”, filed on Aug. 7, 2012, which is a continuation-in-part of U.S. patent application Ser. No. 12/474,881, entitled “COMPRESSION AND MIXING FOR HEARING ASSISTANCE DEVICES”, filed on May 29, 2009, which claims priority to U.S. Provisional Patent Application Ser. No. 61/058,101, entitled “COMPRESSION AND MIXING FOR HEARING ASSISTANCE DEVICES”, filed on Jun. 2, 2008, all of which are hereby incorporated by reference herein in their entirety.

### TECHNICAL FIELD

This document relates generally to hearing assistance systems and more particularly to methods and apparatus for selective harmonic enhancement for hearing assistance devices.

### BACKGROUND

Hearing assistance devices, such as hearing aids, include, but are not limited to, devices for use in the ear, in the ear canal, completely in the canal, and behind the ear. Such devices have been developed to ameliorate the effects of hearing losses in individuals. Hearing deficiencies can range from deafness to hearing losses where the individual has impairment responding to different frequencies of sound or to being able to differentiate sounds occurring simultaneously. The hearing assistance device in its most elementary form usually provides for auditory correction through the amplification and filtering of sound provided in the environment with the intent that the individual hears better than without the amplification.

Hearing aids employ different forms of amplification to achieve improved hearing. However, with improved amplification comes a need for noise reduction techniques to improve the listener's ability to hear amplified sounds of interest as opposed to noise. Numerous noise reduction approaches have been proposed. However, most traditional approaches to noise reduction not only fail to improve speech intelligibility, they can degrade it. Hence, there is a recent increase in research focused on speech enhancement algorithms that have the specific goal of improving speech intelligibility, some even at the expense of speech quality. Binary masking approaches (for single channel speech enhancement) are a prominent example in this direction, and have been shown to significantly improve intelligibility. Unfortunately, binary mask methods tend to introduce objectionable artifacts that make their application unsuitable for general listening and for incorporation in a hearing aid application. Both binary masking and more conventional statistical approaches to noise reduction are driven by short-time local (sub-band) signal-to-noise ratio (SNR) estimates to produce either smooth or abrupt gain functions. Algorithms producing smoother gain functions produce fewer artifacts, but less noise reduction, and consequently less benefit to the listener, and possibly degraded intelligibility. All short-time spectral (or sub-band) domain speech isolation/enhancement techniques, including binary masking, harmonic extraction, and spectral subtraction, share this tradeoff between noise reduction and sound quality. Enhancing speech in the presence of noise is still the biggest challenge for the hearing aid industry.

Accordingly, there is a need in the art for methods and apparatus for improved speech enhancement for hearing assistance devices. Such methods should enhance intelligibility, clarity, and audibility of speech in the presence of background noise.

### SUMMARY

Disclosed herein, among other things, are systems and methods for improved speech enhancement for hearing assistance devices. One aspect of the present subject matter includes a method of enhancing speech in an audio signal for a hearing assistance device. An audio signal is received from a hearing assistance device microphone in a user acoustic environment, and speech components are identified and isolated from the audio signal. The isolated speech components are then mixed back in with the audio signal for a hearing assistance device. In various embodiments, the isolated speech components are processed separately before mixing. In one embodiment, the isolated speech components are harmonically enhanced in parallel with a primary path of the audio signal before mixing.

One aspect of the present subject matter includes hearing assistance device. According to various embodiments, the hearing assistance device includes a microphone and a speech isolating module configured to receive an audio signal from the microphone and to identify and isolate speech components from the audio signal. In various embodiments, the hearing assistance device includes a processor configured to mix the isolated speech components with the audio signal for the hearing assistance device. The hearing assistance device includes a harmonic generator configured to harmonically enhance the speech components, in various embodiments. In various embodiments, the processor is configured to mix the harmonically enhanced speech components with the audio signal for of the hearing assistance device.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 illustrates a block diagram of a system for using harmonic enhancement and filtering of audio signals.

FIG. 2 illustrates a block diagram of a system for using a nonlinear processor to generate harmonics.

FIG. 3 illustrates a block diagram of a system for speech enhancement for a hearing assistance device, according to various embodiments of the present subject matter.

FIG. 4 shows a block diagram of a hearing assistance device, according to one embodiment of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing assistance devices using the example of hearing aids. Hearing aids are only one type of hearing assistance device. Other hearing assistance devices include, but are not limited to, those in this document. It is understood that their use in the description is intended to demonstrate the present subject matter, but not in a limited or exclusive or exhaustive sense.

Enhancing speech in the presence of noise is one of the biggest challenges for the hearing aid industry. One problem shared by conventional noise reduction algorithms is that they do not improve the local signal-to-noise ratio (SNR) within individual time-frequency (TF) cells. The present subject matter generates new speech information that is introduced into TF cells, thereby increasing the local SNR in those cells.

Previously, conventional noise reduction approaches (e.g., Wiener filtering, spectral subtraction, etc.) identify speech-like or high-SNR TF cells, and suppress the others to some degree. Typically, gain or attenuation is applied to individual TF cells according to an estimate of the local SNR. An extreme example of such an approach is the binary mask, which consists of binary gains that suppress or entirely eliminates the energy in TF cells dominated by noise, or those with low local SNR, and retain only the energy of TF cells dominated by the speech target, or those with high local SNR.

However, conventional approaches scale both the speech and noise in a given TF cell by the same amount. For this reason, the local SNR within a given cell remains unchanged after processing. Thus, while speech quality may be improved, speech intelligibility is typically degraded, or at best unchanged. Ideal binary masks, or binary masks generated assuming the knowledge of true local SNRs (which in general are not known, in practice) have been shown to markedly improve intelligibility of noisy speech, at the expense of some quality degradation. While the efficacy of the ideal binary masks for improving speech intelligibility has been studied extensively in the literature, there are as yet very few practical approaches for estimation of such masks. The few existing approaches have a number of drawbacks, including significant reduction in sound quality, little (if any) improvement of speech intelligibility (as compared to the ideal binary masks), and, in some instances, performance that depends critically on the particular type of noise in the environment.

Disclosed herein, among other things, are systems and methods for improved speech enhancement for hearing assistance devices. One aspect of the present subject matter includes a method of enhancing speech in an audio signal for a hearing assistance device. An audio signal is received from a hearing assistance device microphone in a user acoustic environment, and speech components are identified and isolated from the audio signal. The isolated speech components are then mixed back in with the audio signal to improve speech intelligibility and/or clarity for a user of the hearing assistance device. In various embodiments, the isolated speech components are processed separately before mixing. In one embodiment, the isolated speech components are harmonically enhanced in parallel with a primary path of the audio signal before mixing.

The present subject matter applies aggressive speech isolation techniques, such as binary masking, to identify and isolate TF cells that are strongly dominated by the speech (target) energy, in various embodiments. Such cells are then used to reconstruct the speech-only parts of the noisy mixture, in an embodiment. Harmonic distortion is then applied to the isolated speech-only signal to generate new speech energy, in various embodiments. This new energy can be generated in TF cells that were previously consumed by noise, and whose energy was suppressed by aggressive speech isolation, in various embodiments.

In various embodiments, the present subject matter adapts a distortion threshold by varying the amount of harmonic enhancement according to characteristics of the signal or the acoustic environment, such that more or different harmonics are generated when and at which frequencies they provide the most benefit. The harmonically enhanced speech-only signal is mixed into the primary processing path, in various embodiments. Speech harmonics are thereby added to parts of the signal that might otherwise be corrupted by noise, with the aim of improving the local SNR in those TF regions.

The present subject matter uses a unique combination of speech enhancement techniques and signal enhancement techniques. In various embodiments, aggressive speech isolation/enhancement is a preprocessor for harmonic enhancement, so that only parts of the signal strongly dominated by target speech are harmonically enhanced. According to various embodiments, a floating threshold (or “drive” control) is used and is governed by environment classification or SNR estimation. The floating threshold controls the harmonics generation, so the amount of harmonic enhancement is environment or signal dependent, and not merely level dependent, as in conventional in distortion circuits. Typically, there is a threshold above which harmonic enhancement (distortion) occurs, such that more harmonics are generated for higher input signal levels, in various embodiments. In various embodiments, the present subject matter adaptively adjusts this threshold according to the signal characteristics so that greater enhancement is provided when needed or when beneficial, and not only when the input is loud.

Optionally, this selective harmonic enhancement is integrated with other sub-band gain processing (noise reduction or other gain adaptation) approaches to attenuate the unprocessed noisy speech signal in the regions where harmonic enhancement is contributing harmonics.

Conventional short-time spectral domain approaches to noise reduction identify high-SNR TF cells, i.e., those with significant speech (target) energy, and suppress the others, such as those dominated by the noise (masker) energy. Such previous techniques are unable to improve the local SNR because they apply the same gain to the target-masker mixture (i.e., the target and masker energies are scaled by the same amount). Furthermore, cells with considerable noise energy are generally attenuated by the conventional approaches, further reducing audibility of the target in such cells. In contrast, in the present subject matter harmonics are generated from cells dominated by speech, and added to other cells (spectral regions) that may have been dominated by noise, thereby increasing the effective local SNR in those noise-dominated cells.

Aggressive application of speech enhancement methods, such as estimated binary masks, typically introduces many artifacts to the signal being processed, including the “musical noise.” This is because such methods attempt to apply strong attenuation to a mixture of rapidly changing target and masker signals. It is this rapid variation that introduces musical noise. Therefore, practical application of these methods involves a great deal of smoothing to mask musical noise and other artifacts. This smoothing improves some aspects of speech quality, but at the same time compromises the effectiveness of the noise reduction and any potential gains in speech intelligibility.

In contrast, various embodiments of the present subject matter include processing by noise reduction followed by harmonic generation added as enhancement, rather than replacement for the noisy input signal. The enhanced signal, which may include objectionable artifacts or distortion when heard in isolation, is mixed in to the primary (“unprocessed”) signal path in various embodiments, which masks those artifacts and distortion.

Harmonic enhancement itself is a distortion process, and in music production, is generally applied only in small amounts, to prevent the “sweetening” from being perceived as objectionable distortion or corruption of the signal. In various embodiments of the present subject matter, the amount of distortion is modulated by features of the acoustic environment, such as the signal-to-noise ratio, so that in quiet and low-noise environments, enhancement is mild or absent, but in noisier environments, the amount of distortion is increased, providing more harmonic enhancement where and when it is most beneficial.

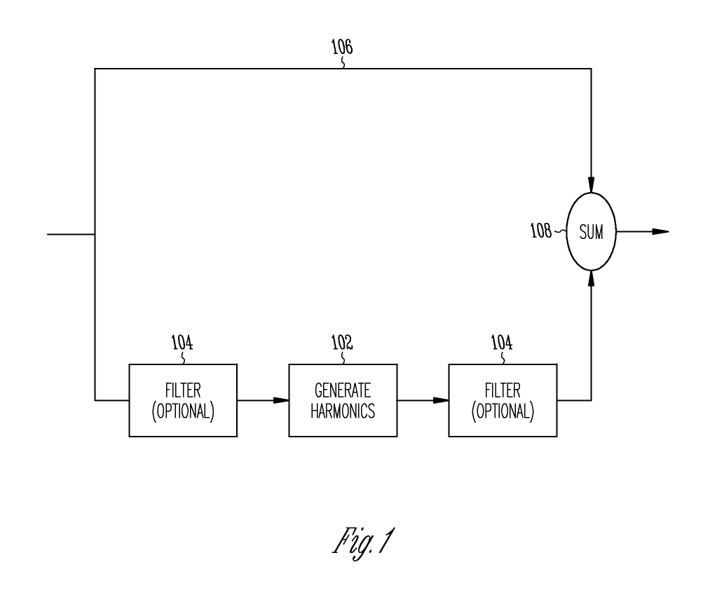

Harmonic enhancement has been used as a sweetening technique in commercial music production. Typically, harmonics are generated by applying nonlinear distortion to the music, or to individual voices or instruments, possibly with band-pass filtering of the signal before and/or after the nonlinearity, as depicted in FIG. 1. FIG. 1 illustrates a block diagram of a system for using harmonic enhancement and filtering of audio signals. A harmonic generator 102 is used to enhance a signal in parallel with (or in a side-chain) the primary signal path 106, then added to the unprocessed signal using a summer 108. In various embodiments, filters 104 (such as band-pass filters) are used either before or after harmonic enhancement, or both. In different variations, this processing may be used to make some sources, like vocals, cut through a dense mix of instruments, or to add brightness and clarity to a dull-sounding recording.

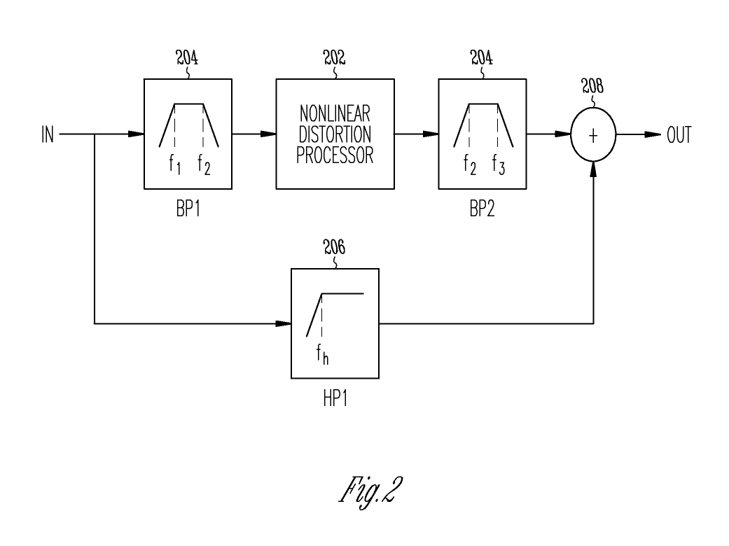

FIG. 2 shows a diagram of a system used to enhance bass perception in systems having limited low-frequency response. The system uses a nonlinear distortion processor 202 to generate harmonics. The depicted system also uses band-pass filters 204, a high pass filter 206, and a summer 208. The high pass filter 206 prevents excessive (beyond the system capacity) low frequencies from reaching further reproduction stages, such as small loudspeakers.

The present subject matter applies binary masking or other aggressive speech enhancement to identify and isolate time-frequency cells that are strongly dominated by speech, and to reconstruct a noise-free signal from the speech-only parts, in various embodiments. This reconstructed signal may be of poor sound quality, but will contain only the highest-SNR (speech dominated) parts of the noisy speech. This speech-only signal is then harmonically enhanced and mixed back into the noisy speech signal, in various embodiments. The aggressive speech enhancement ensures that only harmonics of the speech signal are produced, and not harmonics of the noise. By applying speech isolation in a “side chain” (that is, processing in a parallel signal branch, and mixing the processed signal back into the primary signal path, as opposed to processing inline, with only one signal path), artifacts introduced by the speech isolation process can be masked by the unprocessed signal. An example of separating sound and mixing can be found in commonly assigned, U.S. patent application Ser. No. 13/568,618, entitled “COMPRESSION OF SPACED SOURCES FOR HEARING ASSISTANCE DEVICES”, filed on Aug. 7, 2012, which is hereby incorporated by reference in its entirety. In various embodiments, two kinds of artifacts are masked: 1) the so-called “musical noise,” caused by non-smooth gain functions, characteristic of binary masking techniques, and 2) degradation of speech that is already audible, due to the unnatural sound that arises from suppressing low-SNR parts of the speech signal, producing gaps in the time-frequency space.

Harmonic enhancement is implemented by nonlinear distortion (sometimes called waveshaping) of the source signal in various embodiments, and typically those nonlinear processors introduce more harmonics for higher input signal levels, such that soft speech in quiet would receive relatively less enhancement than loud speech in a noisy environment. If this behavior is not desired, an automatic gain control (AGC) circuit is used to provide a consistent signal level at the input to the nonlinearity, thereby achieving a relatively consistent level of enhancement, in various embodiments. The compensating gain is applied after the nonlinearity to return the enhanced signal to its original level, in various embodiments.

In various embodiments, the level of the signal driving the nonlinear processor is modulated according to some feature of the acoustic environment, or according to an environment classifier, such that more enhancement is applied under conditions in which it would be most beneficial. Depending on the specific implementation of the nonlinear processor, this is implemented by way of a floating gain or threshold parameter governed by an acoustic feature detector, classifier, or analyzer, in various embodiments. For example, in quiet, harmonic enhancement may not be needed, but in noisier or otherwise more demanding environments, the distortion level is increased to generate more harmonics.

Harmonic enhancement increases the local SNR in a way that conventional speech enhancement techniques cannot, because new harmonic energy (due to speech) is added into a TF cell without increasing the gain (and hence the level of noise) in that cell. In various embodiments, to increase the benefit accrued by harmonic enhancement, the present subject matter is integrated with a multichannel compressor, or a conventional noise reduction processor, such that the cells receiving the new harmonic energy receive reduced gain, making the speech harmonics more audible, decreasing the level of the noise and replacing low-SNR noisy speech with “clean” speech harmonics. In various embodiments, gain is applied by the compressor or noise reduction system before the harmonics are introduced.

The present subject matter applies a binary mask at the input to the harmonics generator (nonlinear processor), in various embodiments. In various embodiments, the present subject matter uses a floating threshold or distortion level, governed by features of the input signal or acoustic environment. According to various embodiments, the present subject matter is integrated with a compressor or noise reduction system that reduces the gain applied to the noisy signal in spectral regions receiving the generated harmonics.

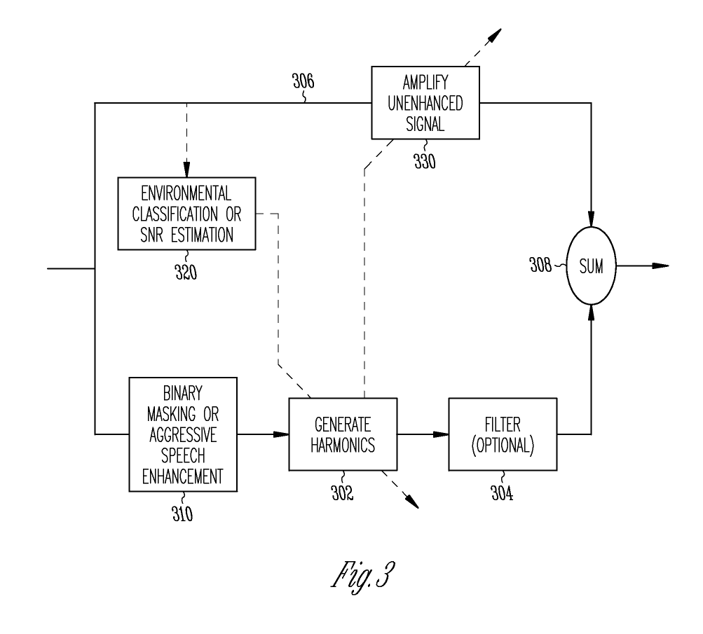

FIG. 3 illustrates a block diagram of a system for speech enhancement for a hearing assistance device, according to various embodiments of the present subject matter. An input signal is processed with a binary mask or aggressive speech enhancement 310 before being enhanced using a harmonic enhancer or harmonic generator 302 in a side-chain, or in parallel with the primary signal path. In various embodiments, the harmonic generator is omitted and the isolated signal is no harmonically enhanced before mixing with the unprocessed signal to improve speech intelligibility and clarity. A filter, such as a band-pass filter 304, can be used with the harmonic generator in various embodiments. A summer 308 combines the enhanced signal with the unprocessed or non-enhanced signal, in various embodiments. In various embodiments, the system includes optional integration with an environment classifier 320 in the unenhanced signal branch. In further embodiments, the system includes optional integration with a gain processor 330 in the unenhanced signal branch. In another embodiment, the system includes optional integration with a delay unit (not shown) in the unenhanced signal branch. The environment classifier 320 regulates the generation of the harmonics, in various embodiments. The gain processor 330 reduces gain where harmonics are generated, in an embodiment. The delay unit compensates for the processing latency introduced in the enhancement branch, and preserves the temporal alignment between the enhanced and unenhanced signals, in various embodiments.

Additional embodiments are possible without departing from the scope of the present subject matter. In various embodiments, in place of binary masking based on SNR, other kinds of speech isolation processing are applied. For example, harmonic extraction is used to isolate only the voiced parts of speech, or speech recognition and synthesis is used in place of speech enhancement or isolation to generate the source for the harmonic enhancement. In yet another embodiment, an aggressive single-channel noise reduction algorithm, one that isolates only the top spectral components (in terms of highest energy or SNR) belonging predominantly to speech, is used in place of the binary masking algorithm. If the amount of harmonic enhancement is a function of the acoustic environment, other methods of determining and classifying the environment can be used, such as, for example, location-aware systems on smart phones.

In various embodiments, in place of a nonlinear distortion (or waveshaping) unit, other kinds of nonlinear processing can be used to produce the enhanced signal from the isolated speech. One such technique, known in the field of music production as bit crushing, reduces the digital word length used to represent the processed signal thereby introducing distortion due to quantization. In another embodiment, the enhancement can be performed by modulation of the isolated speech signal. In further embodiments, harmonic enhancement can be performed in the frequency (or subband) domain, by convolution or other processes that introduce energy in a frequency region as a function of energy in a different frequency region.

In various embodiments, additional benefit can be achieved by treating the primary or “unprocessed” signal path with a very mild amount of the same sort of processing that the side-chain receives. Therefore, in this embodiment, the upper signal branch in FIG. 3 is treated with mild harmonic enhancement, without the binary masking or speech isolation.

The present subject matter restores target energy in TF cells dominated by noise energy. This is achieved by harmonic enhancement of binary masked speech, in various embodiments. The harmonically restored target energy may include some undesirable abrupt artifacts. In another embodiment, the present subject matter applies processing to mitigate such artifacts in harmonically enhanced binary masked speech, prior to mixing it with the signal from the primary processing path. More specifically the broad formant structure (i.e., the spectral envelope) of the harmonically enhanced signal is further improved, so that it more closely matches the smooth formant structure of the clean speech. In various embodiments, the fine structure of the harmonically enhanced binary masked speech is discarded and replaced by that of the unprocessed signal (i.e., noisy mixture), or enhanced signal (i.e., from the output of a noise reduction side-chain). Smooth spectral envelope extraction can be achieved in a variety of standard DSP methods, including auto-regressive modeling and cepstral liftering. The artifact reduced restoration of the target signal is then mixed in with the signal from the primary processing path, in various embodiments. In another embodiment, multiple harmonic enhancement side-chains are used, each based on a different approach for isolation of target energy. The output of the best side-chain is then selected for a given situation. Alternatively, a linear combination of side-chain outputs is used. These are then mixed-in with the signal from the primary processing path, in various embodiments. The present subject matter provides improved speech enhancement technology that improves speech clarity and intelligibility.

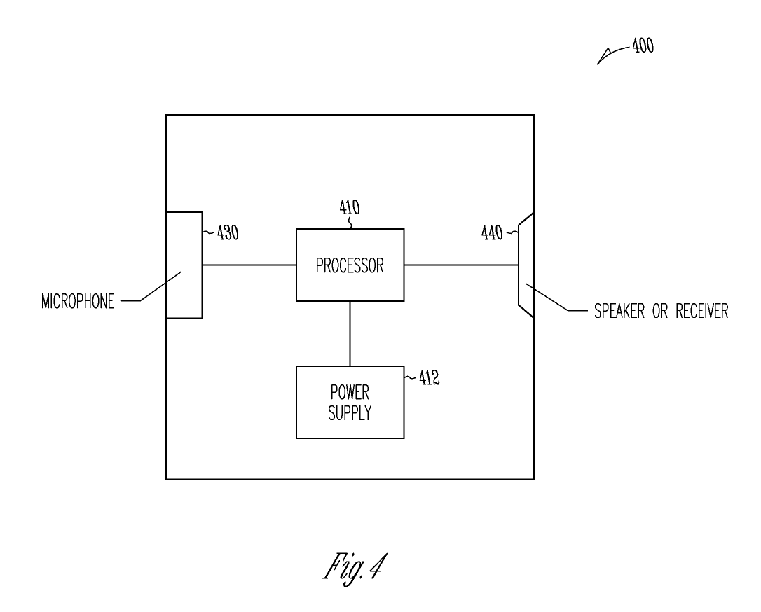

FIG. 4 shows a block diagram of a hearing assistance device 400 according to one embodiment of the present subject matter. In this exemplary embodiment the hearing assistance device 400 includes a processor 410 and at least one power supply 412. In one embodiment, the processor 410 is a digital signal processor (DSP). In one embodiment, the processor 410 is a microprocessor. In one embodiment, the processor 410 is a microcontroller. In one embodiment, the processor 410 is a combination of components. It is understood that in various embodiments, the processor 410 can be realized in a configuration of hardware or firmware, or a combination of both. In various embodiments, the processor 410 is programmed to provide different processing functions depending on the signals sensed from the microphone 430. In hearing aid embodiments, microphone 430 is configured to provide signals to the processor 410 which are processed and played to the wearer with speaker 440 (also known as a “receiver” in the hearing aid art).

One example, which is intended to demonstrate the present subject matter, but is not intended in a limiting or exclusive sense, is that the signals from the microphone 430 are detected to determine the presence of speech. Processor 410 may take different actions depending on whether the speech is detected or not. Processor 410 can be programmed in a plurality of modes to change operation upon detection of the signal of interest (for example, speech). In various embodiments, more than one processor is used.

Other inputs may be used in combination with the microphone or instead of the microphone. For example, signals from a number of different signal sources can be detected using the teachings provided herein, such as audio information from a FM radio receiver, signals from a BLUETOOTH or other wireless receiver, signals from a magnetic induction source, signals from a wired audio connection, signals from a cellular phone, or signals from any other signal source.

Various embodiments of the present subject matter support wireless communications with a hearing assistance device. In various embodiments the wireless communications can include standard or nonstandard communications. Some examples of standard wireless communications include link protocols including, but not limited to, Bluetooth™, IEEE 802.11(wireless LANs), 802.15 (WPANs), 802.16 (WiMAX), cellular protocols including, but not limited to CDMA and GSM, ZigBee, and ultra-wideband (UWB) technologies. Such protocols support radio frequency communications and some support infrared communications. Although the present system is demonstrated as a radio system, it is possible that other forms of wireless communications can be used such as ultrasonic, optical, infrared, and others. It is understood that the standards which can be used include past and present standards. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, SPI, PCM, ATM, Fibre-channel, Firewire or 1394, InfiniBand, or a native streaming interface. In various embodiments, such connections include all past and present link protocols. It is also contemplated that future versions of these protocols and new future standards may be employed without departing from the scope of the present subject matter.

It is understood that variations in communications protocols, antenna configurations, and combinations of components may be employed without departing from the scope of the present subject matter. Hearing assistance devices typically include an enclosure or housing, a microphone, hearing assistance device electronics including processing electronics, and a speaker or receiver. It is understood that in various embodiments the microphone is optional. It is understood that in various embodiments the receiver is optional. Antenna configurations may vary and may be included within an enclosure for the electronics or be external to an enclosure for the electronics. Thus, the examples set forth herein are intended to be demonstrative and not a limiting or exhaustive depiction of variations.

It is further understood that any hearing assistance device may be used without departing from the scope and the devices depicted in the figures are intended to demonstrate the subject matter, but not in a limited, exhaustive, or exclusive sense. It is also understood that the present subject matter can be used with a device designed for use in the right ear or the left ear or both ears of the user.

It is understood that the hearing aids referenced in this patent application include a processor. The processor may be a digital signal processor (DSP), microprocessor, microcontroller, other digital logic, or combinations thereof. The processing of signals referenced in this application can be performed using the processor. Processing may be done in the digital domain, the analog domain, or combinations thereof. Processing may be done using subband processing techniques. Processing may be done with frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, audio decoding, and certain types of filtering and processing. In various embodiments the processor is adapted to perform instructions stored in memory which may or may not be explicitly shown. Various types of memory may be used, including volatile and nonvolatile forms of memory. In various embodiments, instructions are performed by the processor to perform a number of signal processing tasks. In such embodiments, analog components are in communication with the processor to perform signal tasks, such as microphone reception, or receiver sound embodiments (i.e., in applications where such transducers are used). In various embodiments, different realizations of the block diagrams, circuits, and processes set forth herein may occur without departing from the scope of the present subject matter.

The present subject matter is demonstrated for hearing assistance devices, including hearing aids, including but not limited to, behind-the-ear (BTE), in-the-ear (ITE), in-the-canal (ITC), receiver-in-canal (RIC), completely-in-the-canal (CIC) or invisible-in-canal (IIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard, open fitted or occlusive fitted. It is understood that other hearing assistance devices not expressly stated herein may be used in conjunction with the present subject matter.

In addition, the present subject matter can be used in other settings in addition to hearing assistance. Examples include, but are not limited to, telephone applications where noise-corrupted speech is introduced, and streaming audio for ear pieces or headphones.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A method, comprising:
receiving an audio signal from a hearing assistance device microphone in a user acoustic environment;
identifying and isolating speech components from the audio signal;
harmonically enhancing the speech components in parallel with a primary path of the audio signal; and
mixing the harmonically enhanced speech components with the audio signal for a hearing assistance device.

2. The method of claim 1, wherein identifying and isolating speech components includes identifying and isolating time-frequency cells that are primarily composed of speech.

3. The method of claim 2, wherein harmonically enhancing the speech components includes harmonically enhancing the time-frequency cells that are primarily composed of speech to add energy to the time-frequency cells.

4. The method of claim 1, wherein identifying and isolating speech components includes using binary masking.

5. The method of claim 1, wherein harmonically enhancing the speech components includes using nonlinear distortion.

6. The method of claim 1, wherein harmonically enhancing the speech components includes controlling the harmonic enhancement using a floating threshold.

7. The method of claim 6, comprising controlling the floating threshold using environment classification, so the harmonic enhancement is dependent on the user acoustic environment.

8. The method of claim 6, comprising controlling the floating threshold using signal-to-noise ratio (SNR) estimation, so the harmonic enhancement is dependent on the estimated SNR.

9. The method of claim 1, wherein the harmonic enhancement is integrated with other sub-band gain processing.

10. The method of claim 9, wherein the harmonic enhancement is integrated with noise reduction.

11. The method of claim 9, wherein the harmonic enhancement is integrated with gain adaptation.

12. The method of claim 1, further comprising using an automatic gain control (AGC) circuit configured to provide a consistent signal level for the harmonic enhancement.

13. The method of claim 1, wherein the harmonic enhancement is controlled by an acoustic feature detector.

14. The method of claim 1, wherein identifying and isolating speech components includes harmonic extraction.

15. The method of claim 1, wherein identifying and isolating speech components includes speech recognition.

16. A hearing assistance device, comprising:
a microphone;
a speech isolating module configured to receive an audio signal from the microphone and to identify and isolate speech components from the audio signal;
a harmonic generator configured to harmonically enhance the speech components; and
a processor configured to mix the harmonically enhanced speech components with the audio signal for the hearing assistance device.

17. The device of claim 16, wherein the processor includes a digital signal processor (DSP).

18. The device of claim 16, further comprising an automatic gain control (AGC) circuit configured to provide a consistent signal level to the harmonic generator.

19. The device of claim 16, wherein the harmonic generator is controlled by an acoustic feature detector.

20. The device of claim 19, wherein the acoustic feature detector includes an environment classifier.

21. The device of claim 19, wherein the acoustic feature detector includes a signal-to-noise ratio (SNR) estimator.

22. The device of claim 16, wherein the speech isolating module includes a binary masking module.

23. The device of claim 16, wherein the speech isolating module includes a harmonic extraction module.

24. The device of claim 16, wherein the speech isolating module includes a speech recognition module.

25. The device of claim 16, further comprising multiple harmonic enhancement paths, each based on a different approach for isolation of target energy, wherein the output of the only path is selected based on predetermined criteria.
